(19) United States
(12) Patent Application Publication
(10) Pub. No.: US 2014/0112210 A1
(43) Pub. Date: Apr. 24, 2014

(54) Method for Group Call, Terminal, and Application Server

(71) Applicant: Huawei Device Co., LTD, Shenzhen (CN)

(72) Inventor: Li Zhang, Shenzhen (CN)

(21) Appl. No.: 14/143,873

(22) Filed: Dec. 30, 2013

Related U.S. Application Data
(63) Continuation of application No. PCT/CN2012/082696, filed on Oct. 10, 2012.

(30) Foreign Application Priority Data
Oct. 14, 2011 (CN) 201110311490.3

(51) Int. Cl. H04L 29/06

(52) U.S. Cl. CPC H04L 65/403
USPC 370/260

(57) ABSTRACT

A method for a group call, includes, when a terminal having a speaking right needs to shield a listening right of one or more terminals in a group during a group call, receiving a start demarcative call message sent by the terminal having the speaking right. The start demarcative call message carries an identifier of a shielded terminal. The listening right of the shielded terminal is shielded according to the identifier of the shielded terminal.

### CROSS-REFERENCE TO RELATED APPLICATIONS

This application is a continuation of International Application No. PCT/CN2012/082696, filed on Oct. 10, 2012, which claims priority to Chinese Patent Application No. CN201110311490.3, filed on Oct. 14, 2011, all of which are hereby incorporated by reference in their entireties.

### TECHNICAL FIELD

The present invention relates to the field of communications, and in particular, to a method for a group call, a terminal, and an application server.

### BACKGROUND

QChat is an application on a VoIP (Voice over IP (Internet Protocol, Internet protocol), IP phone), which supports one-to-one and one-to-many radio voice communication in half-duplex mode, where only one person has a speaking right to speak at any time. At present, the QChat is usually used to perform a one-to-many group call, where one person in the group has the speaking right to speak, while other persons in the group only have a listening right to listen.

There are a large number of members in the group, and the speaker may intend to control a listening range in a period of time, namely, allow a part of persons to listen, and forbid other persons to listen. At present, the function of controlling a listening range cannot be provided to a speaker in a QChat group call, so that the speaker cannot control the listening range of the group.

### SUMMARY OF THE INVENTION

To enable a terminal having a speaking right to control a listening range of a group, the present invention provides a method for a group call, a terminal, and an application server. The technical solutions are as follows.

A method for a group call includes when a terminal having a speaking right needs to shield a listening right of one or more terminals in a group during a group call, receiving a start demarcative call message sent by the terminal having the speaking right, where the start demarcative call message carries an identifier of a shielded terminal, and shielding the listening right of the shielded terminal according to the identifier of the shielded terminal.

A method for a group call includes when a terminal having a speaking right needs to shield a listening right of one or more terminals in a group during a group call, obtaining an identifier of a shielded terminal, and sending a start demarcative call message to an application server, where the start demarcative call message carries the identifier of the shielded terminal, so that the application server shields the listening right of the shielded terminal according to the identifier of the shielded terminal.

An application server includes a first receiving module, configured to: when a terminal having a speaking right needs to shield a listening right of one or more terminals in a group during a group call, receive a start demarcative call message sent by the terminal having the speaking right, where the start demarcative call message carries an identifier of a shielded terminal, and a shielding module, configured to shield the listening right of the shielded terminal according to the identifier of the shielded terminal.

A terminal includes an obtaining module, configured to: when a terminal having a speaking right needs to shield a listening right of one or more terminals in a group during a group call, obtain an identifier of a shielded terminal, and a third sending module, configured to send a start demarcative call message to an application server, where the start demarcative call message carries the identifier of the shielded terminal, so that the application server shields the listening right of the shielded terminal according to the identifier of the shielded terminal.

In the present invention, when the terminal having the speaking right needs to shield the listening right of one or more terminals in the group during the group call, the start demarcative call message sent by the terminal having the speaking right is received, and the listening right of the shielded terminal is shielded according to the identifier of the shielded terminal carried in the start demarcative call message, so that the terminal having the speaking right can control the listening range of the group.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a flow chart of a method for a group call according to Embodiment 1 of the present invention;

FIG. 2 is a flow chart of a method for a group call according to Embodiment 2 of the present invention;

FIG. 3 is a schematic diagram of a network architecture according to Embodiment 2 of the present invention;

FIG. 4 is a flow chart of a method for a group call according to Embodiment 3 of the present invention;

FIG. 5 is a schematic diagram of a network architecture according to Embodiment 3 of the present invention;

FIG. 6 is a flow chart of a method for a group call according to Embodiment 4 of the present invention;

FIG. 7 is a schematic diagram of an application server according to Embodiment 5 of the present invention; and

FIG. 8 is a schematic diagram of a terminal according to Embodiment 6 of the present invention.

### DETAILED DESCRIPTION OF ILLUSTRATIVE EMBODIMENTS

To make the objectives, technical solutions, and advantages of the present invention more comprehensible, the following further describes the embodiments of the present invention in detail with reference to the accompanying drawings.

### Embodiment 1

As shown in FIG. 1, an embodiment of the present invention provides a method for a group call. The method includes the following steps.

Step 101: When a terminal having a speaking right needs to shield a listening right of one or more terminals in a group during a group call, receive a start demarcative call message sent by the terminal having the speaking right, where the start demarcative call message carries an identifier of a shielded terminal.

Step 102: Shield the listening right of the shielded terminal according to the identifier of the shielded terminal.

The identifier of the terminal may include an address of the terminal or number information used to identify the identity of the terminal.

In the embodiment of the present invention, when the terminal having the speaking right needs to shield the listening right of one or more terminals in the group during the group call, the start demarcative call message sent by the terminal having the speaking right is received, and the listening right of the shielded terminal is shielded according to the identifier of the shielded terminal carried in the start demarcative call message, so that the terminal having the speaking right can control the listening range of the group.

### Embodiment 2

An embodiment of the present invention provides a method for a group call.

In this embodiment, a plurality of terminals first makes a request to a QAS (QChat Application Server, QChat application server) to perform a group call in a unicast form, and send their identifiers to the QAS at the same time; the QAS receives the identifiers of the plurality of terminals, enables the plurality of terminals to form a group, and sends the identifiers of the plurality of terminals to each terminal in the group so that each terminal knows members of the group where each terminal is located; and each terminal in the group receives and stores the identifiers of the plurality of terminals sent by the QAS; and at any time, only one terminal in the group has a speaking right, while other terminals in the group only have a listening right, namely, a terminal having the speaking right may send a voice data packet to the QAS, and the QAS receives the voice data packet, determines a group where the terminal having the speaking right is located, obtains each of the other terminals in the group except the terminal having the speaking right, and sends the voice data packet to each obtained terminal.

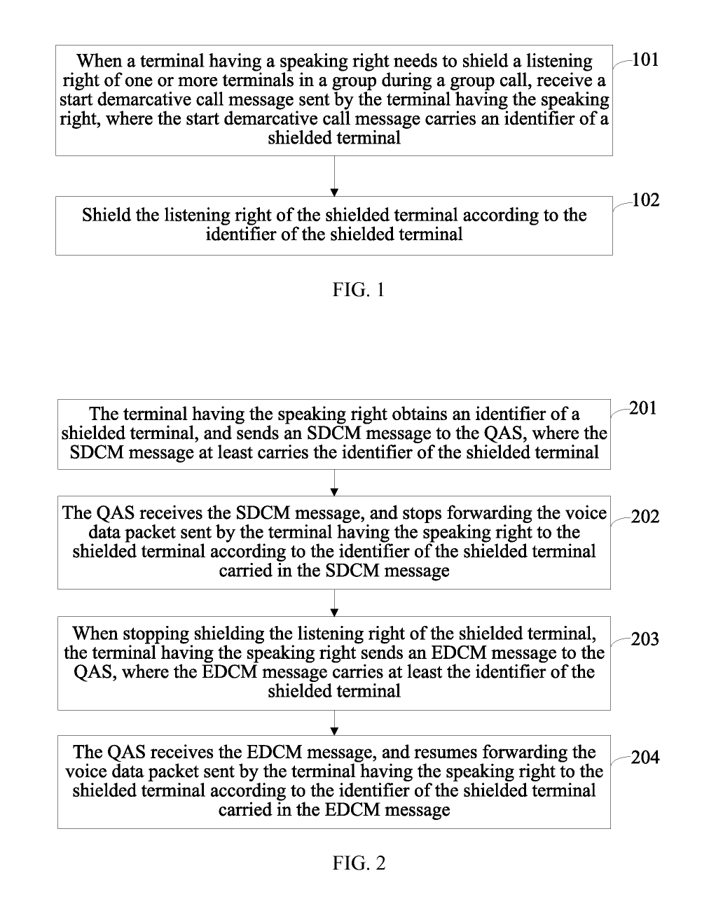

In this embodiment, a terminal having a speaking right can control a listening range of a group, namely, shield a listening right of one or more terminals in the group, where the terminal having the speaking right may shield the listening right of one or more terminals in the group by using the method provided in this embodiment. Referring to FIG. 2, the method includes the following steps.

Step 201: The terminal having the speaking right obtains an identifier of a shielded terminal, and sends an SDCM (Start Demarcative Call Message, start demarcative call message) message to the QAS, where the SDCM message carries at least the identifier of the shielded terminal.

Specifically, the terminal having the speaking right obtains an identifier of a shielded terminal stored by the terminal having the speaking right, and then sends an SDCM message to the QAS, where the SDCM message carries the identifier of the shielded terminal.

A user may select a shielded terminal, and trigger the terminal having the speaking right to shield the listening right of the shielded terminal, and then the terminal having the speaking right executes the operation of obtaining the identifier of the shielded terminal and sending an SDCM message.

Furthermore, the SDCM message may further carry other information, for example, the SDCM message may further carry an instruction used to notify the shielded terminal.

The SDCM message includes a first field, where the first field may be used to carry the identifier of the shielded terminal. Furthermore, the SDCM message may further include a second field, where the second field may be used to carry other information, for example, the second field may be used to carry the instruction used to notify the shielded terminal.

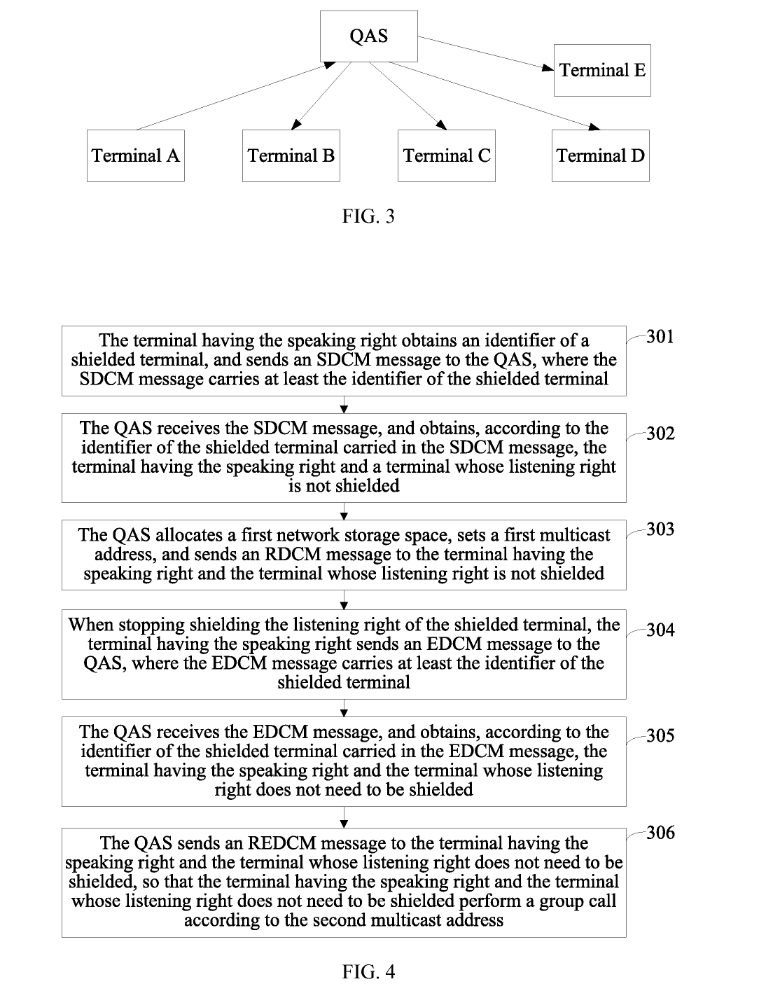

For example, referring to FIG. 3, terminals A, B, C, D, and E first send a call request message to the QAS to request the QAS to perform a group call, where the call request message sent by the terminals carries identifiers of the terminals; the QAS receives the call request messages sent by the terminals A, B, C, D, and E, enables the terminals A, B, C, D, and E to form a group, and sends the identifiers of the terminals in the group to each of the terminals A, B, C, D, and E at the same time; and the terminals A, B, C, D, and E receive and store the identifiers of the terminals sent by the QAS.

If the terminal A has the speaking right of the group, and the terminal A needs to shield the listening right of the terminals D and E, the terminal A obtains an IPD and an IPE that are stored, where the IPD and the IPE are identifiers of the terminals D and E, respectively, and sends an SDCM message to the QAS, where the SDCM message carries the identifiers of the shielded terminals D and E, and further carries an instruction used to notify the shielded terminals.

Step 202: The QAS receives the SDCM message, and stops forwarding the voice data packet sent by the terminal having the speaking right to the shielded terminal according to the identifier of the shielded terminal carried in the SDCM message.

The QAS stops forwarding the voice data packet sent by the terminal having the speaking right to the shielded terminal, so that the listening right of the shielded terminal is shielded.

Furthermore, if the SDCM message further carries the instruction used to notify the shielded terminal, the QAS notifies the shielded terminal according to the instruction used to notify the shielded terminal and carried in the SDCM message.

The QAS may send the received SDCM message to the shielded terminal to notify the shielded terminal.

After the QAS stops forwarding the voice data packet sent by the terminal having the speaking right to the shielded terminal, when receiving the voice data packet sent by the terminal having the speaking right, the QAS obtains each of other terminals included in the group where the terminal having the speaking right is located except the terminal having the speaking right, removes the shielded terminal from all the obtained terminals according to the identifier of the shielded terminal, and forwards the voice data packet sent by the terminal having the speaking right to the remaining terminals, so that the voice data packet sent by the terminal having the speaking right stops being forwarded to the shielded terminal.

For example, the QAS receives the SDCM message sent by the terminal A, extracts the identifier IPD of the shielded terminal D and the identifier IPE of the shielded terminal E from the SDCM message, and stops forwarding the voice data packet sent by the terminal A to the shielded terminals D and E according to the identifier IPD of the shielded terminal D and the identifier IPE of the shielded terminal E; when receiving the voice data packet sent by the terminal A, the QAS obtains other terminals B, C, D, and E included in the group where the terminal A is located except the terminal A, removes the shielded terminals D and E from the obtained terminals B, C, D, and E according to the identifier IPD of the shielded terminal D and the identifier IPE of the shielded terminal E, and forwards the voice data packet sent by the terminal A to the remaining terminals B and C, so that the voice data packet sent by the terminal A stops being forwarded to the shielded terminals D and E.

Furthermore, after receiving the SDCM message, the QAS may further send the SDCM message to the shielded terminals D and E according to the instruction used to notify the shielded terminals and carried in the SDCM message.

Furthermore, after the QAS stops forwarding the voice data packet sent by the terminal having the speaking right to the shielded terminal, the QAS may send a preset voice data packet to the shielded terminal. The preset voice data packet may be a piece of music.

Step 203: When stopping shielding the listening right of the shielded terminal, the terminal having the speaking right sends an EDCM (End Demarcative Call Message, end demarcative call message) message to the QAS, where the EDCM message carries at least the identifier of the shielded terminal.

Furthermore, the EDCM message may further carry other information, for example, the EDCM message may further carry an instruction used to notify the shielded terminal.

The EDCM message may include a first field, where the first field may be used to carry the identifier of the shielded terminal. Furthermore, the EDCM message may further include a second field, where the second field may be used to carry other information, for example, the second field may be used to carry the instruction used to notify the shielded terminal.

For example, when needing to stop shielding the shielded terminals D and E, the terminal A sends an EDCM message, where the EDCM message carries the identifier IPD of the shielded terminal D, the identifier IPE of the shielded terminal E and the instruction used to notify the shielded terminals.

Step 204: The QAS receives the EDCM message, and resumes forwarding a voice data packet sent by the terminal having the speaking right to the shielded terminal according to the identifier of the shielded terminal carried in the EDCM message.

The QAS resumes forwarding the voice data packet sent by the terminal having the speaking right to the shielded terminal, so that the listening right of the shielded terminal stops being shielded.

Furthermore, if the EDCM message further carries the instruction used to notify the shielded terminal, the QAS notifies the shielded terminal according to the instruction used to notify the shielded terminal and carried in the EDCM message.

The QAS may send the received EDCM message to the shielded terminal to notify the shielded terminal.

After the QAS resumes forwarding the voice data packet sent by the terminal having the speaking right to the shielded terminal, when receiving the voice data packet sent by the terminal having the speaking right, the QAS obtains other terminals included in the group where the terminal having the speaking right is located, except the terminal having the speaking right, where the obtained terminals include the shielded terminal, and forwards the voice data packet sent by the terminal having the speaking right to the obtained terminals, so as to resume forwarding the voice data packet sent by the terminal having the speaking right to the shielded terminal.

For example, the QAS receives the EDCM message sent by the terminal A, resumes forwarding the voice data packet sent by the terminal A to the shielded terminals D and E according to the identifier IPD of the shielded terminal D and the identifier IPE of the shielded terminal E carried in the EDCM message; and when the QAS receives the voice data packet sent by the terminal A, the QAS obtains other terminals, that is, the terminals B, C, D, and E included in the group where the terminal A is located except the terminal A, and forwards the voice data packet sent by the terminal A to the obtained terminals B, C, D, and E.

In the embodiment of the present invention, the terminal having the speaking right sends the SDCM message to the QAS, where the SDCM message carries the identifier of the shielded terminal, and the QAS stops forwarding the voice data packet sent by the terminal having the speaking right to the shielded terminal according to the identifier of the shielded terminal carried in the SDCM message, so as to shield the listening right of the shielded terminal, so that the terminal having the speaking right can control the listening range of the group.

### Embodiment 3

An embodiment of the present invention provides a method for a group call.

In this embodiment, a plurality of terminals first makes a request to a QAS to perform a group call in a multicast form, and sends their identifiers to the QAS at the same time; the QAS receives the identifiers of the plurality of terminals and enables the plurality of terminals to form a group, allocates a second network storage space, sets a second multicast address for the second network storage space, sends the second multicast address to each terminal in the group, and sends the identifiers of the plurality of terminals to each terminal in the group at the same time so that each terminal knows members in the group where each terminal is located; and each terminal in the group receives and stores the identifiers of the plurality of terminals and the second multicast address that are sent by the QAS; and at any time, only one terminal in the group has a speaking right, while other terminals in the group only have a listening right, namely, a terminal having the speaking right may send a voice data packet to the second network storage space according to the second multicast address, and each of the other terminals in the group obtains the voice data packet sent by the terminal having the speaking right from the second network storage space according to the second multicast address.

In this embodiment, a terminal having a speaking right can control a listening range of a group, namely, shield a listening right of one or more terminals in the group, where the terminal having the speaking right may shield the listening right of one or more terminals in the group by using the method provided in this embodiment. Referring to FIG. 4, the method includes the following steps.

Step 301: The terminal having the speaking right obtains an identifier of a shielded terminal, and sends an SDCM message to the QAS, where the SDCM message carries at least the identifier of the shielded terminal.

Specifically, the terminal having the speaking right obtains an identifier of a shielded terminal stored by the terminal having the speaking right, and then sends an SDCM message to the QAS, where the SDCM message carries the identifier of the shielded terminal.

A user may select a shielded terminal, and trigger the terminal having the speaking right to shield the listening right of the shielded terminal, and then the terminal having the speaking right executes the operation of obtaining the identifier of the shielded terminal and sending an SDCM message.

Furthermore, the SDCM message may further carry other information, for example, the SDCM message may further carry an instruction used to notify the shielded terminal.

The SDCM message includes a first field, where the first field may be used to carry the identifier of the shielded terminal. Furthermore, the SDCM message may further include a second field, where the second field may be used to carry other information, for example, the second field may be used to carry the instruction used to notify the shielded terminal.

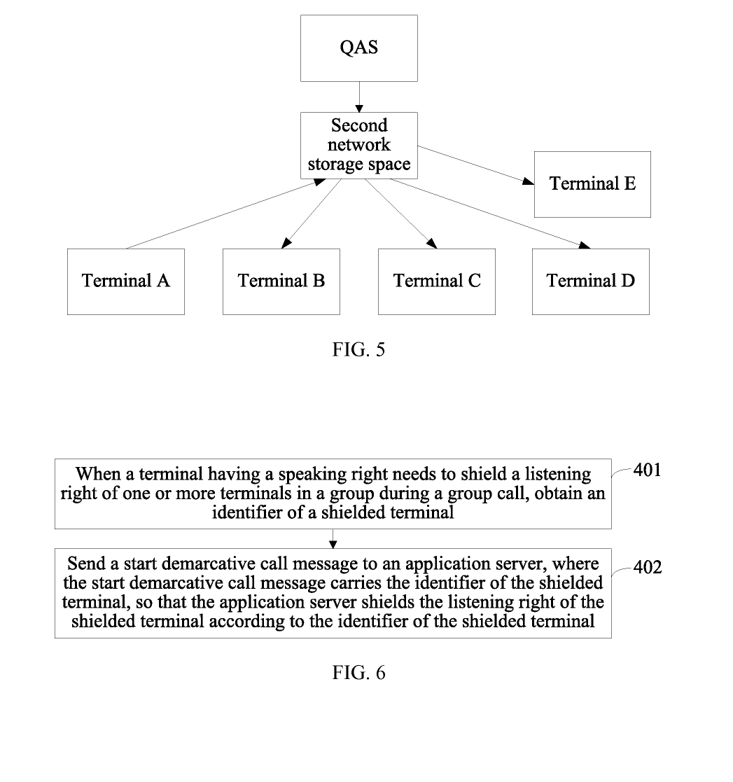

For example, referring to FIG. 5, terminals A, B, C, D, and E first send a call request message to the QAS to request the QAS to perform a group call, where the call request message sent by the terminals carries identifiers of the terminals; the QAS receives the call request messages sent by the terminals A, B, C, D, and E, enables the terminals A, B, C, D, and E to form a group, allocates the second network storage space, allocates a second multicast address IP1 to the second network storage space, then sends the second multicast address IP1 to the terminals A, B, C, D, and E in the group, and sends the identifier of each terminal in the group to the terminals A, B, C, D, and E at the same time; and the terminals A, B, C, D, and E receive and store the identifier of each terminal in the group and the second multicast address IP1 that are sent by the QAS.

If the terminal A has the speaking right of the group, and the terminal A needs to shield the listening right of the terminals D and E, the terminal A obtains an IPD and an IPE that are stored by the terminal A, where the IPD and the IPE are identifiers of the terminals D and E, respectively, and sends an SDCM message to the QAS, where the SDCM message carries the identifiers of the shielded terminals D and E, and further carries an instruction used to notify the shielded terminals.

Step 302: The QAS receives the SDCM message, and obtains, according to the identifier of the shielded terminal carried in the SDCM message, the terminal having the speaking right and a terminal whose listening right does not need to be shielded.

Specifically, the QAS receives the SDCM message, obtains each terminal included in the group where the terminal having the speaking right is located, and removes the shielded terminal from all the obtained terminals according to the identifier of the shielded terminal carried in the SDCM message, and the remaining terminals include the terminal having the speaking right and the terminal whose listening right does not need to be shielded.

Furthermore, if the SDCM message further carries an instruction used to notify the shielded terminal, the QAS notifies the shielded terminal according to the instruction used to notify the shielded terminal and carried in the SDCM message.

The QAS may send the received SDCM message to the shielded terminal to notify the shielded terminal.

For example, the QAS receives the SDCM message sent by the terminal A, obtains the terminals A, B, C, D, and E included in the group where the terminal A is located, extracts the identifier IPD of the shielded terminal D and the identifier IPE of the shielded terminal E from the SDCM message, removes the shielded terminals D and E from the terminals A, B, C, D, and E according to the identifier IPD of the shielded terminal D and the identifier IPE of the shielded terminal E, and obtains the terminal A having the speaking right and the terminals B and C whose listening right does not need to be shielded.

Furthermore, after the QAS receives the SDCM message, the QAS may further send the SDCM message to the shielded terminals D and E according to the instruction used to notify the shielded terminals and carried in the SDCM message.

Step 303: The QAS allocates a first network storage space, sets a first multicast address of the first network storage space, and sends an RDCM (Response Demarcative Call Message, response demarcative call message) message to the terminal having the speaking right and the terminal whose listening right does not need to be shielded.

The terminal having the speaking right and the terminal whose listening right does not need to be shielded receive the first multicast address sent by the QAS; when needing to send a voice data packet, the terminal having the speaking right sends the voice data packet to the first network storage space according to the first multicast address; and the terminal whose listening right does not need to be shielded obtains the voice data packet sent by the terminal having the speaking right from the first network storage space according to the first multicast address, so that the listening right of the shielded terminal is shielded.

For example, the QAS allocates the first network storage space, sets a first multicast address IP2 of the first network storage space, and sends the first multicast address IP2 to the terminals A, B, and C; and the terminals A, B, and C each receive the first multicast address IP2 sent by the QAS.

When needing to send a voice data packet, the terminal A sends the voice data packet to the first network storage space according to the first multicast address IP2; and the terminals B and C obtain the voice data packet sent by the terminal A from the first network storage space according to the first multicast address IP2, so that the listening right of the terminals D and E is shielded.

Furthermore, the QAS may send a preset voice data packet to the second network storage space. Correspondingly, the shielded terminal may obtain the preset voice data packet from the second network storage space according to the second multicast address.

Step 304: When stopping shielding the listening right of the shielded terminal, the terminal having the speaking right sends an EDCM message to the QAS, where the EDCM message carries at least the identifier of the shielded terminal.

Furthermore, the EDCM message may further carry other information, for example, the EDCM message may further carry an instruction used to notify the shielded terminal.

The EDCM message may include a first field, where the first field may be used to carry the identifier of the shielded terminal. Furthermore, the EDCM message may further include a second field, where the second field may be used to carry other information, for example, the second field may be used to carry the instruction used to notify the shielded terminal.

For example, when needing to stop shielding the listening right of the shielded terminal D and the shielded terminal E, the terminal A sends the EDCM message to the QAS, where the EDCM message carries the identifier IPD of the shielded terminal D, the identifier IPE of the shielded terminal E and the instruction used to notify the shielded terminals.

Step 305: The QAS receives the EDCM message, and obtains, according to the identifier of the shielded terminal carried in the EDCM message, the terminal having the speaking right and the terminal whose listening right does not need to be shielded.

Specifically, the QAS receives the EDCM message, obtains each terminal included in the group where the terminal having the speaking right is located, and removes the shielded terminal from all the obtained terminals according to the identifier of the shielded terminal carried in the EDCM message, and the remaining terminals include the terminal having the speaking right and the terminal whose listening right does not need to be shielded.

Furthermore, if the EDCM message further carries the instruction used to notify the shielded terminal, the QAS notifies the shielded terminal according to the instruction used to notify the shielded terminal and carried in the EDCM message.

The QAS may send the received EDCM message to the shielded terminal to notify the shielded terminal.

For example, the QAS receives the EDCM message sent by the terminal A, obtains the terminals A, B, C, D, and E included in the group where the terminal A is located, extracts the identifier IPD of the shielded terminal D and the identifier IPE of the shielded terminal E from the EDCM message, removes the shielded terminals D and E from the terminals A, B, C, D, and E according to the identifier IPD of the shielded terminal D and the identifier IPE of the shielded terminal E, and obtains the terminal A having the speaking right and the terminals B and C whose listening right does not need to be shielded.

Furthermore, after the QAS receives the EDCM message, the QAS may further send the EDCM message to the shielded terminals D and E according to the instruction used to notify the shielded terminals and carried in the EDCM message.

Step 306: The QAS sends an REDCM (Response End Demarcative Call Message, response end demarcative call message) message to the terminal having the speaking right and the terminal whose listening right does not need to be shielded, so that the terminal having the speaking right and the terminal whose listening right does not need to be shielded perform a group call according to the second multicast address.

After the terminal having the speaking right and the terminal whose listening right does not need to be shielded receive the REDCM message sent by the QAS, if the terminal having the speaking right needs to send a voice data packet, the terminal having the speaking right sends the voice data packet to the second network storage space according to the second multicast address, and the terminal whose listening right does not need to be shielded and the shielded terminal both obtain the voice data packet sent by the terminal having the speaking right from the second network storage space according to the second multicast address, so that the listening right of the shielded terminal stops being shielded.

For example, the QAS sends an REDCM message to the terminal A having the speaking right and the terminals B and C whose listening right does not need to be shielded, and the terminals A, B, and C each receive the REDCM message; when the terminal A needs to send a voice data packet, the terminal A sends the voice data packet to the second network storage space according to the second multicast address IP1; and the terminals B, C, D, and E obtain the voice data packet sent by the terminal A from the second network storage space according to the second multicast address, so as to stop shielding the listening right of the shielded terminals D and E.

In the embodiment of the present invention, the terminal having the speaking right sends the SDCM message to the QAS, where the SDCM message carries the identifier of the shielded terminal, the QAS obtains, according to the identifier of the shielded terminal carried in the SDCM message, the terminal having the speaking right and the terminal whose listening right does not need to be shielded, allocates the first network storage space, and sends the first multicast address of the first network storage space to the terminal having the speaking right and the terminal whose listening right does not need to be shielded, and the terminal having the speaking right and the terminal whose listening right does not need to be shielded perform the group call according to the first multicast address, so as to shield the listening right of the shielded terminal, so that the terminal having the speaking right can control the listening range of the group.

### Embodiment 4

As shown in FIG. 6, an embodiment of the present invention provides a method for a group call. The method includes the following steps:

Step 401: When a terminal having a speaking right needs to shield a listening right of one or more terminals in a group during a group call, obtain an identifier of a shielded terminal.

Step 402: Send a start demarcative call message to an application server, where the start demarcative call message carries the identifier of the shielded terminal, so that the application server shields the listening right of the shielded terminal according to the identifier of the shielded terminal.

In the embodiment of the present invention, when the terminal having the speaking right needs to shield the listening right of one or more terminals in the group during the group call, the start demarcative call message is sent to the application server, so that the application server shields the listening right of the shielded terminal according to the identifier of the shielded terminal carried in the start demarcative call message, so that the terminal having the speaking right can control the listening range of the group.

### Embodiment 5

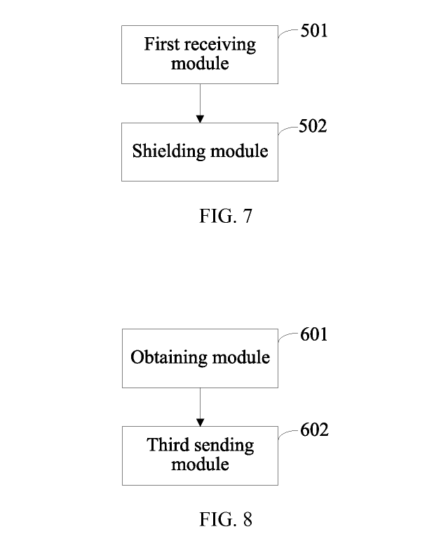

As shown in FIG. 7, an embodiment of the present invention provides an application server, which includes a first receiving module 501, configured to: when a terminal having a speaking right needs to shield a listening right of one or more terminals in a group during a group call, receive a start demarcative call message sent by the terminal having the speaking right, where the start demarcative call message carries an identifier of a shielded terminal, and a shielding module 502, configured to shield the listening right of the shielded terminal according to the identifier of the shielded terminal.

The shielding module 502 is specifically configured to stop forwarding a voice data packet sent by the terminal having the speaking right to the shielded terminal according to the identifier of the shielded terminal, so as to shield the listening right of the shielded terminal.

Furthermore, the application server further includes a first sending module, configured to send a preset voice data packet to the shielded terminal.

The shielding module 502 includes a first obtaining unit, configured to obtain, according to the identifier of the shielded terminal, the terminal having the speaking right and a terminal whose listening right does not need to be shielded in the group, and an allocation unit, configured to allocate a first network storage space, and set a first multicast address of the first network storage space, and a sending unit, configured to send the first multicast address to the terminal having the speaking right and the terminal whose listening right does not need to be shielded, so that the terminal having the speaking right and the terminal whose listening right does not need to be shielded perform a group call according to the first multicast address, so as to shield the listening right of the shielded terminal.

Furthermore, the application server further includes a second sending unit, configured to send a preset voice data packet to a second network storage space, so that the shielded terminal obtains the preset voice data packet from a corresponding second network storage space according to a second multicast address.

Furthermore, the application server further includes: a second receiving module and a stopping module, where the second receiving module is configured to: when the terminal having the speaking right stops shielding the listening right of the shielded terminal, receive an end demarcative call message sent by the terminal having the speaking right, where the end demarcative call message carries the identifier of the shielded terminal, and the stopping module is configured to stop shielding the listening right of the shielded terminal according to the identifier of the shielded terminal.

Furthermore, the stopping module is specifically configured to resume forwarding a voice data packet sent by the terminal having the speaking right to the shielded terminal according to the identifier of the shielded terminal, so as to stop shielding the listening right of the shielded terminal.

Furthermore, the stopping module includes a second obtaining unit, configured to obtain, according to the identifier of the shielded terminal, the terminal having the speaking right and a terminal whose listening right does not need to be shielded in the group, and a sending unit, configured to send a response end demarcative call message to the terminal having the speaking right and the terminal whose listening right does not need to be shielded, so that the terminal having the speaking right and the terminal whose listening right does not need to be shielded perform a group call according to a second multicast address.

Furthermore, the start demarcative call message further carries an instruction used to notify the shielded terminal, and correspondingly, the application server further includes a notification module, configured to notify the shielded terminal according to the instruction used to notify the shielded terminal.

In this embodiment, the application server may be a QAS.

In the embodiment of the present invention, when the terminal having the speaking right needs to shield the listening right of one or more terminals in the group during the group call, the start demarcative call message sent by the terminal having the speaking right is received, and the listening right of the shielded terminal is shielded according to the identifier of the shielded terminal carried in the start demarcative call message, so that the terminal having the speaking right can control the listening range of the group.

### Embodiment 6

As shown in FIG. 8, an embodiment of the present invention provides a terminal, which includes an obtaining module 601, configured to: when a terminal having a speaking right needs to shield a listening right of one or more terminals in a group during a group call, obtain an identifier of a shielded terminal, and a third sending module 602, configured to send a start demarcative call message to an application server, where the start demarcative call message carries the identifier of the shielded terminal, so that the application server shields the listening right of the shielded terminal according to the identifier of the shielded terminal.

Furthermore, the terminal further includes a third receiving module, configured to receive a first multicast address sent by the application server, and send a voice data packet to a corresponding first network storage space according to the first multicast address.

Furthermore, the terminal further includes a fourth sending module, configured to: when the terminal having the speaking right stops shielding the listening right of the shielded terminal, send an end demarcative call message to the application server, where the end demarcative call message carries the identifier of the shielded terminal, so that the application server stops shielding the listening right of the shielded terminal according to the identifier of the shielded terminal.

Furthermore, the terminal further includes a fourth receiving module, configured to receive an response end demarcative call message sent by the application server, and send a voice data packet to a corresponding second network storage space according to a stored second multicast address.

In the embodiment of the present invention, when the terminal having the speaking right needs to shield the listening right of one or more terminals in the group during the group call, the start demarcative call message is sent to the application server, so that the application server shields the listening right of the shielded terminal according to the identifier of the shielded terminal carried in the start demarcative call message, so that the terminal having the speaking right can control the listening range of the group.

It should be noted that, in the embodiments of the present invention, the start demarcative call message may, in addition to carrying an identifier of a terminal that needs to be shielded, also only carry an identifier of a terminal that does not need to be shielded in the group call, or the message may carry identifiers of all the terminals in the group call, in such case, the message needs to carry the identifiers of both the terminal that needs to be shielded and the terminal that does not need to be shielded are identified.

Persons of ordinary skill in the art may understand that all or a part of the steps of the foregoing embodiments may be implemented through hardware, or may be implemented by a program instructing relevant hardware. The program may be stored in a computer readable storage medium. The storage medium may be a read-only memory, a magnetic disk, or an optical disk.

The foregoing descriptions are merely exemplary embodiments of the present invention, but are not intended to limit the present invention. Any modification, equivalent replacement, or improvement derived within the spirit and principle of the present invention shall fall within the protection scope of the present invention.

What is claimed is:

1. A method for a group call, comprising:
receiving a start demarcative call message sent by a terminal having a speaking right; and
shielding a listening right of a part of terminals in group call terminals according to the start demarcative call message.

2. The method according to claim 1, wherein the start demarcative call message carries identification information comprising an identifier of a terminal that needs to be shielded in the group call terminals and/or an identifier of a terminal that does not need to be shielded in the group call terminals.

3. The method according to claim 1, wherein shielding the listening right of a part of terminals in group call terminals comprises:
stopping forwarding of a voice data packet sent by the terminal having the speaking right to the part of terminals, so as to shield the listening right of the part of terminals.

4. The method according to claim 1, wherein, after shielding the listening right of the part of terminals, the method further comprise sending a preset voice data packet to the part of terminals.

5. The method according to claim 2, wherein shielding the listening right of a part of terminals in group call terminals comprises:
obtaining, according to the identification information whose listening right does not need to be shielded in the group call terminals;
allocating a first network storage space;
setting a first multicast address of the first network storage space; and
sending the first multicast address to the terminal having the speaking right and the terminal whose listening right does not need to be shielded, so that the terminal having the speaking right and the terminal whose listening right does not need to be shielded perform a group call according to the first multicast address, thereby shielding the listening right of the terminal that needs to be shielded.

6. The method according to claim 5, wherein, after shielding the listening right of a part of terminals in group call terminals, the method further comprises:
sending the preset voice data packet to a second network storage space, so that the part of terminals obtains the preset voice data packet according to a second multicast address.

7. The method according to claim 2, further comprising:
receiving an end demarcative call message sent by the terminal having the speaking right, when the terminal having the speaking right stops shielding the listening right of the part of terminals, wherein the end demarcative call message carries the identifier of the part of terminals; and
stopping shielding of the listening right of the part of terminals according to the identifier of the part of terminals.

8. The method according to claim 7, wherein stopping shielding of the listening right of the part of terminals according to the identifier of the part of terminals comprises:
resuming forwarding of a voice data packet sent by the terminal having the speaking right to the part of terminals according to the identifier of the part of terminals, so as to stop shielding the listening right of the part of terminals.

9. The method according to claim 7, wherein stopping shielding of the listening right of the part of terminals according to the identification information comprises:
obtaining, according to the identifier of the part of terminals, the terminal having the speaking right and a terminal whose listening right does not need to be shielded in the group; and
sending a response end demarcative call message to the terminal having the speaking right and the terminal whose listening right does not need to be shielded, so that the terminal having the speaking right and the terminal whose listening right does not need to be shielded perform a group call according to the second multicast address.

10. A method for a group call, comprising:
during a group call, obtaining an identifier of a shielded terminal when a terminal having a speaking right needs to shield a listening right of the shielded terminal; and
sending a start demarcative call message to an application server, wherein the start demarcative call message carries an identifier of the shielded terminal, so that the application server can shield the listening right of the shielded terminal according to the identifier of the shielded terminal.

11. The method according to claim 10, wherein, after sending the start demarcative call message to an application server, the method further comprises:
receiving a first multicast address sent by the application server; and
sending a voice data packet to a corresponding first network storage space according to the first multicast address.

12. The method according to claim 10, further comprising:
sending an end demarcative call message to the application server, when the terminal having the speaking right stops shielding the listening right of the shielded terminal, wherein the end demarcative call message carries the identifier of the shielded terminal so that the application server can stop shielding the listening right of the shielded terminal.

13. The method according to claim 12, wherein, after sending the end demarcative call message to the application server, the method further comprises:
receiving a response end demarcative call message sent by the application server; and
sending a voice data packet to a corresponding second network storage space according to a stored second multicast address.

14. An application server, comprising:
a first receiving module, configured to receive a start demarcative call message sent by a terminal having a speaking right, when the terminal having the speaking right needs to shield a listening right of one or more terminals in a group during a group call, wherein the start demarcative call message carries an identifier of a shielded terminal; and
a shielding module, configured to shield a listening right of the shielded terminal according to the identifier of the shielded terminal.

15. The application server according to claim 14, wherein the shielding module is configured to stop forwarding a voice data packet sent by the terminal having the speaking right to the shielded terminal according to the identifier of the shielded terminal, so as to shield the listening right of the shielded terminal.

16. The application server according to claim 14, further comprising a first sending module, configured to send a preset voice data packet to the shielded terminal.

17. The application server according to claim 14, wherein the shielding module comprises:
a first obtaining unit, configured to obtain, the terminal having the speaking right and a terminal whose listening right does not need to be shielded in the group according to the identifier of the shielded terminal;
an allocation unit, configured to allocate a first network storage space and to set a first multicast address of the first network storage space; and
a sending unit, configured to send the first multicast address to the terminal having the speaking right and the terminal whose listening right does not need to be shielded, so that the terminal having the speaking right and the terminal whose listening right does not need to be shielded perform a group call according to the first multicast address.

18. The application server according to claim 14, further comprising:
a second sending unit, configured to send a preset voice data packet to a second network storage space, so that the shielded terminal obtains the preset voice data packet from a corresponding second network storage space according to a second multicast address;
a second receiving module, configured to receive an end demarcative call message sent by the terminal having the speaking right, when the terminal having the speaking right stops shielding the listening right of the shielded terminal, wherein the end demarcative call message carries the identifier of the shielded terminal; and
a stopping module, configured to stop shielding the listening right of the shielded terminal according to the identifier of the shielded terminal.

19. A terminal, comprising:
an obtaining module, configured to obtain identifiers of group call terminals; and
a sending module, configured to send a start demarcative call message to an application server, wherein the start demarcative call message carries an identifier of a terminal that needs to be shielded in the group call terminals and/or an identifier of a terminal that does not need to be shielded in the group call terminals, so that the application server shields, a listening right of the terminal that needs to be shielded, according to the carried identifier of the terminal.

20. The terminal according to claim 19, further comprising:
a receiving module, configured to receive a first multicast address sent by the application server and to send a voice data packet to a corresponding first network storage space according to the first multicast address;
a second sending module, configured to send an end demarcative call message to the application server when the terminal having the speaking right stops shielding the listening right of the shielded terminal, wherein the end demarcative call message carries the identifier of the shielded terminal, so that the application server stops shielding the listening right of the shielded terminal according to the identifier of the shielded terminal;
a second receiving module, configured to receive an response end demarcative call message sent by the application server and to send a voice data packet to a corresponding second network storage space according to a stored second multicast address.
